(19) United States
(12) Patent Application Publication
(10) Pub. No.: US 2016/0231588 A1
(43) Pub. Date: Aug. 11, 2016

(54) Interchangeabal Eyewear

(71) Applicant: Dominick Serge, Redondo Beach, CA (US)

(72) Inventor: Dominick Serge, Redondo Beach, CA (US)

(21) Appl. No.: 15/040,974

(22) Filed: Feb. 10, 2016

Related U.S. Application Data
(60) Provisional application No. 62/114,193, filed on Feb. 10, 2015.

(51) Int. Cl. G02C 1/08; G02C 5/22

(52) U.S. Cl. CPC G02C 1/08; G02C 5/2209; G02C 2200/06; G02C 2200/08

(57) ABSTRACT

The present invention is a fully customizable and interchangeable eyewear frame in which all components of the frame are interchangeable without the use of any tools, equipments or hardware styles to interconnect the components. The present invention provides an eyewear frame comprising a pair of earpieces, a top frame piece, a pair of bottom rim pieces, and a plurality of joints. The plurality of joints includes a pair of joints located at a pair of corners of the top frame piece for holding the pair of earpieces, the top frame piece and an outer edge of the pair of bottom rim pieces together. The plurality of joints further includes a pair of inside joints on a nose bridge area of the top frame piece which connects the other end of the bottom rim piece to the top frame piece.

### CROSS-REFERENCE TO RELATED APPLICATIONS

This application claims the benefit of the U.S. Provisional Application 62/114,193 filed on Feb. 10, 2015.

### STATEMENT REGARDING FEDERALLY SPONSORED RESEARCH AND DEVELOPMENT

Not Applicable.

### FIELD OF THE DISCLOSURE

The present disclosure relates generally to eyewear frames. More specifically, the present disclosure relates to an interchangeable and customizable eyewear frame in which all components of the frame are interchanged to create numerous variations and styles without the use of any tools or hardware styles to interconnect the components.

### DISCUSSION OF RELATED ART

Various types of eyeglasses are available that allow for interchangeability of frame members such as earpieces or lenses. People who wear eyeglasses often purchase more than one pair of eyeglasses for different functional and aesthetic reasons. Different types of eyeglasses may be purchased to increase strength or comfort, to alter the fit or the weight, to vary the flexibility or the rigidity or to provide a different aesthetic look by changing the shape of the frame or the coloring of the frame. Some people purchase more than one pair of eyewear, having a single style of frame, but use one of the frames for tinted lenses and the other for non-tinted lenses which requires carrying both pair of eyewear and must absorb the additional costs associated with the second frame. This requires the purchase of a complete set of eyewear, including the frame and the expensive prescription lenses. While exchanging one set of lenses with another set, these eyewear systems have multiple parts, such as washers, screws, caps and the like, which may be problematic.

Conventional eyewear and safety glasses have temples which have fixed length. Improper length of the temple may lead to discomfort of the wearer. It would be desirable to be able to adjust the eyewear to suit different users, easily and inexpensively. In some prior methods, eyewear frames having interchangeable components including at least one lens structure and a temple that is configured to removably attach to one another is described. In such systems the lens structure includes two engaging elements with one attached to the lens structure towards the center and the other towards the temple having curved portions shaped to secure the temple to the engaging elements of the lens structure. However this system provides a rimless eyewear frame allowing interchangeability of lenses and temple only.

Another method describes an eyeglass frames in which the right and left lens rims are split to facilitate insertion and removal of lenses. A pair of flanges on each rim adjacent the split mate to form a composite lug which is received between upper and lower arms on the associated temple pieces whereby the rims are held in the closed position. Pivot pin means are provided to secure the temple pieces to the lugs on the lens rims. The lug and pivot pin arrangement is generally useful for securing removable temple pieces to lens rims. Even so, the invention is not flexible for replacing the components easily because of the involvement of fastening means such as pivot pin.

Yet another method describes eyewear system enables a person to switch lenses among a variety of frames or switch a variety of lenses within a single frame. The lenses can be easily attached to and detached from a frame assembly that may or may not otherwise contain lenses. The lenses may be frameless or positioned in one or more sub frame assemblies. However, this method requires the use and removal of fasteners which may require mechanical tools to operate, when replacing lenses or making sizing adjustments.

Yet another method discloses eyeglasses of a type which permit interchanging of lenses are disclosed which employ a collapsible frame having a pair of hingedly interconnected lens-mounting portions. The lens-mounting portions are configured to engage the peripheral edge of the lens and include several prongs. The peripheral edge of the lenses includes prong-receiving recesses which position the lenses relative to the frame to provide secure mounting thereto. The lens-mounting portions of the frame also include a separable connection wherein a mounting lug mounted to one part of the section is received in a socket formed at an end of an opposing section. The separable connection allows the lens-mounting portions to open, facilitating mounting and removal of the lenses, and close so as to provide secure mounting of the lens relative to the frame. Moreover, this eyewear system often requires a significant amount of time to change lenses which may become undesirable when the lenses need to be interchanged frequently.

Therefore, there is a need for an eyewear frame which would be fully customizable and interchangeable. Such a needed apparatus would provide a fashion accessory with the ability to interchange different colored pieces of frame without the involvement of fastening means and other hardware tools to create numerous variations and styles. Further, the device would provide a user with both more options and a potential huge savings. The present invention overcomes prior art shortcomings by accomplishing these critical objectives.

### SUMMARY OF THE DISCLOSURE

In a preferred embodiment of the present invention, a fully customizable and interchangeable eyewear frame is provided in which all components of the frame, including earpieces, top of the frame, bottom of the rims and lenses are interchangeable without the use of any tools or hardware styles to interconnect the components. The eyewear frame is primarily a fashion accessory with an ability to interchange different colored, shaped and sized pieces of the frame to create numerous variations and styles with enhanced flexibility.

The present invention provides an eyewear frame comprising a top frame piece, a pair of earpieces, a pair of bottom rim pieces, and a plurality of joints. The top frame piece includes a pair of corners and a nose bridge area in which the pair of corners consists of a left side corner and a right side corner each having a left corner opening and a right corner opening respectively. The nose bridge area includes a hook engaging portion. The pair of earpieces includes an earpiece appendage allowing the pair of earpieces to slide into the left corner opening and the right corner opening located at the pair of corners of the top frame piece. The pair of bottom rim pieces includes a left rim piece and a right rim piece in which the left rim piece is provided with a first corner hook member and a left bridge area hook member and the right rim piece is provided with a second corner hook member and a right bridge area hook member. The left bridge area hook member and the right bridge area hook member being detachably attached to the hook engaging portion at the nose bridge area of the top frame piece. The first corner hook member and the second corner hook member being detachably engaged with the left corner opening and the right corner opening of the top frame piece respectively. The plurality of joints includes a pair of joints at the pair of corners of the top frame piece for holding the pair of earpieces, the top frame piece and an outer edge of the pair of bottom rim pieces together. The plurality of joints further includes a pair of inside joints on the nose bridge area of the top frame piece which connects the other end of the pair of bottom rim piece to the top frame piece. The pair of earpieces is attached from the inside of the frames is rotated to the normal wearing position and locks the pair of earpieces together with the pair of bottom rim pieces and the top frame piece providing interchangeability to create numerous variations and style to the eyewear frame. In order to insert the pair of earpieces into the plurality of joints located at the pair of corners of the top frame piece, the user has to press down on each of the pair of earpieces to flatten and to align the earpiece appendage with the left corner opening and the right corner opening located at the pair of corners of the top frame piece and slides the earpiece appendage into the left corner opening and the right corner opening. The pair of earpieces can be removed by gently pressing down on an arch in the pair of earpieces to the point where it will freely slide out of the plurality of joints. The eyewear frame can be disassembled by removing the pair of earpieces. The pair of bottom rim pieces includes a pair of rim piece groves to support a pair of lenses on its own. The eyewear frame can be made from memory plastics such as TR90 plastics.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is an exploded view of an interchangeable eyewear frame in a disassembled state according to the preferred embodiment of the present invention;

FIG. 2 is a perspective view of the interchangeable eyewear frame showing a second corner hook member of a right rim piece and a right corner opening at a right side corner of a top frame piece in a disengaged state according to the preferred embodiment of the present invention;

FIG. 3 is a perspective view of the interchangeable eyewear frame showing the second corner hook member of the right rim piece and the right corner opening at the right side corner of the top frame piece in an engaged state and adapted to be connected to the pair of earpieces according to the preferred embodiment of the present invention;

FIG. 4 is a perspective view of the interchangeable eyewear frame showing the pair of joints located at a pair of corners of the top frame piece holding the pair of earpieces, the top frame piece and an outer edge of the pair of bottom rim pieces together according to the preferred embodiment of the present invention;

FIG. 5 is a front perspective view of the interchangeable eyewear frame wherein the top frame piece, the pair of bottom rim pieces and the pair of earpieces are locked together according to the preferred embodiment of the present invention; and

FIG. 6 is a side perspective view of the interchangeable eyewear frame wherein the top frame piece, the pair of bottom rim pieces and the pair of earpieces are locked together according to the preferred embodiment of the present invention.

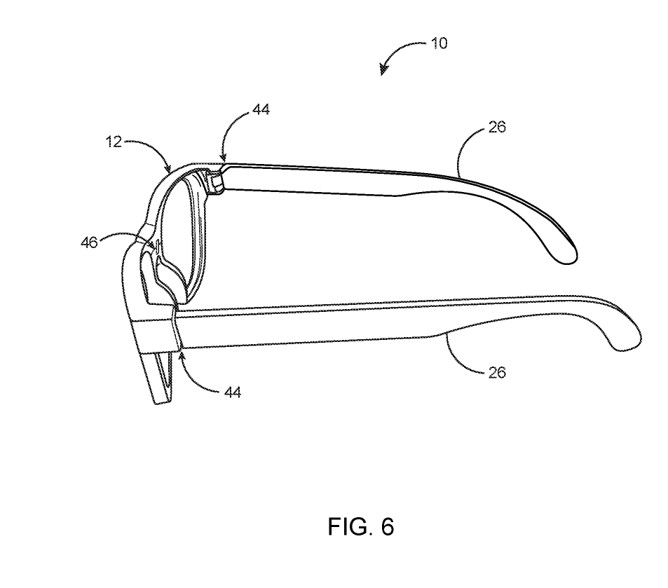

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

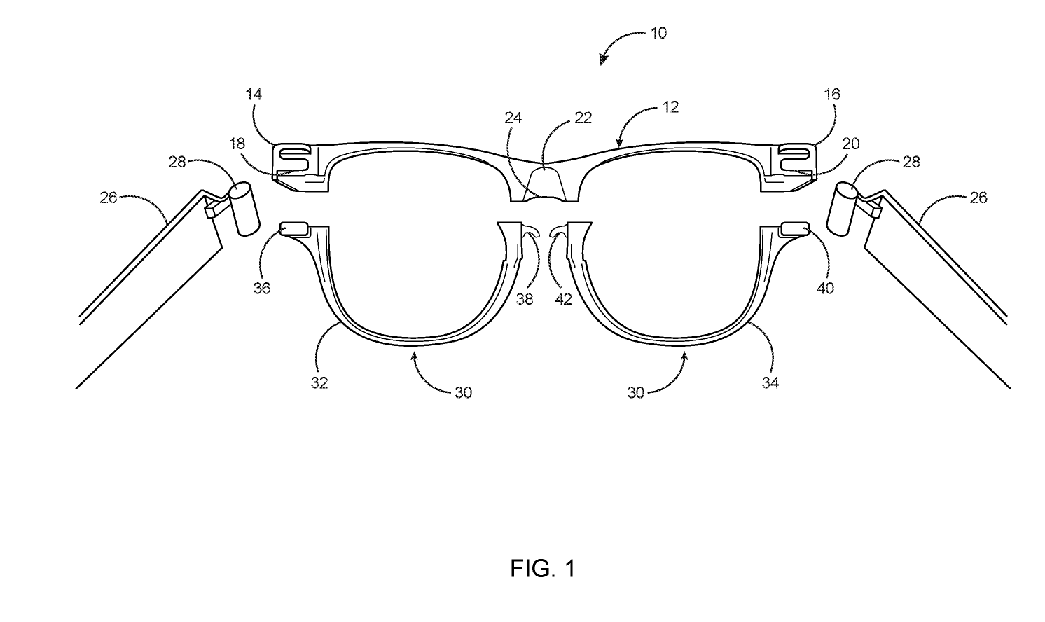

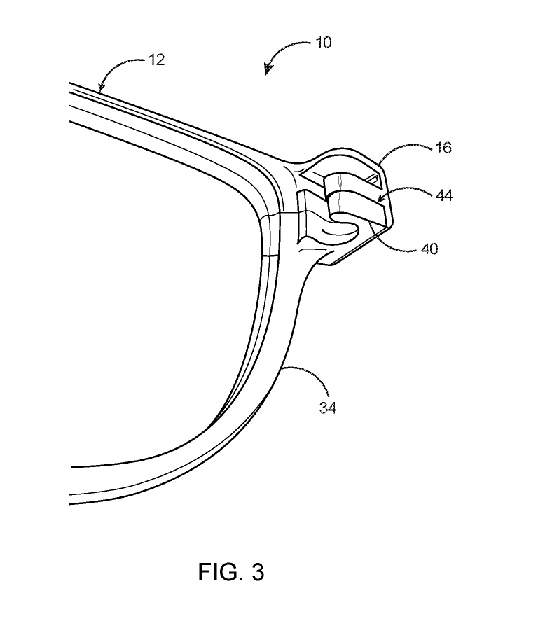

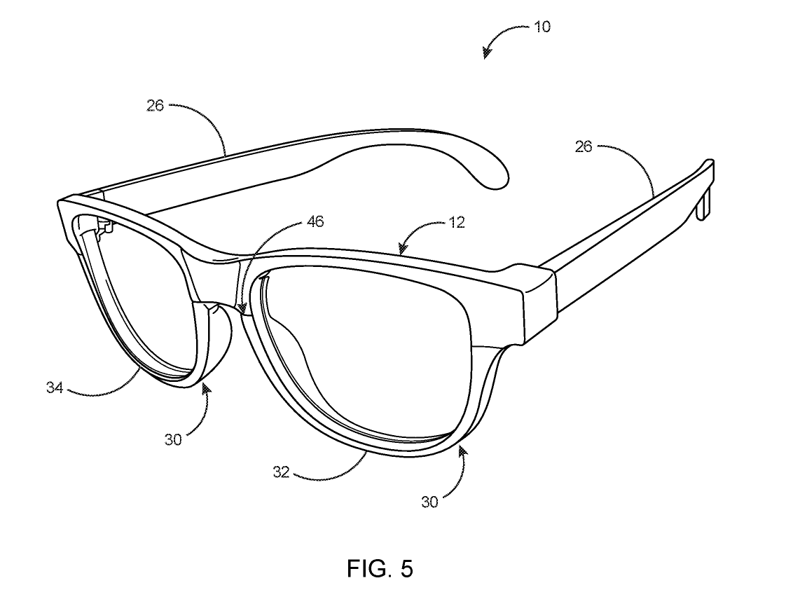

Turning first to FIG. 1, an exploded view of an interchangeable eyewear frame 10 in a disassembled state according to the preferred embodiment of the present invention is illustrated. The eyewear frame 10 comprising a top frame piece 12, a pair of earpieces 26, a pair of bottom rim pieces 30, and a plurality of joints 44 and 46 (See FIGS. 3 & 5). The top frame piece 12 includes a pair of corners 14 and 16 and a nose bridge area 22 in which the pair of corners 14 and 16 consists of a left side corner 14 and a right side corner 16 each having a left corner opening 18 and a right corner opening 20 respectively. The nose bridge area 22 includes a hook engaging portion 24. The pair of earpieces 26 includes an earpiece appendage 28 allowing the pair of earpieces 26 to slide into the left corner opening 18 and the right corner opening 20 located at the pair of corners 14 and 16 of the top frame piece 12. The pair of bottom rim pieces 30 includes a left rim piece 32 and a right rim piece 34 in which the left rim piece 32 is provided with a first corner hook member 36 and a left bridge area hook member 38 and the right rim piece 34 is provided with a second corner hook member 40 and a right bridge area hook member 42.The plurality of joints 44 and 46 (See FIGS. 3 & 5) includes a pair of joints at the pair of corners 44 (See FIG. 3) of the top frame piece 12 for holding the pair of earpieces 26, the top frame piece 12 and an outer edge of the pair of bottom rim pieces 30 together. The plurality of joints 44 and 46 (See FIGS. 3 & 5) further includes a pair of inside joints on the nose bridge area 46 (See FIG. 5) of the top frame piece 12 which connects the other end of the pair of bottom rim pieces 30 to the top frame piece 12.

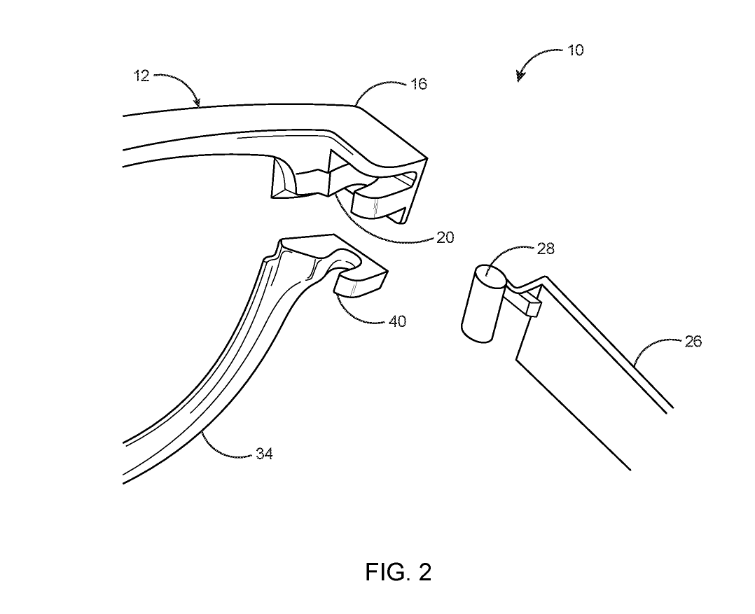

Referring to FIGS. 2 and 3, a perspective view of the interchangeable eyewear frame 10 showing the second corner hook member 40 of the right rim piece 34 and the right corner opening 20 at the right side corner 16 of the top frame piece 12 in a disengaged and engaged state respectively according to the preferred embodiment of the present invention is illustrated. The first corner hook member 36 (See FIG. 1) and the second corner hook member 40 being detachably engaged with the left corner opening 18 (See FIG. 1) and the right corner opening 16 located at the left side corner 14 (See FIG. 1) and the right side 16 corner of the top frame piece 12 respectively. The left bridge area hook member 38 (See FIG. 1) and the right bridge area hook member 42 (See FIG. 1) allows the pair of bottom rim pieces 30 (See FIG. 1) to connect to the top frame piece 12 at the nose bridge area 22 (See FIG. 1) of the top frame piece 12. The left bridge area hook member 38 (See FIG. 1) and the right bridge area hook member 42 (See FIG. 1) helps the pair of bottom rim pieces 30 (See FIG. 1) to swing into place. When inserting lenses in the eyewear frame 10, the lenses must first be placed in the grove of the pair of bottom rim pieces 30 (See FIG. 1) wherein the groves are designed to support the lenses on its own. Therefore, the pair bottom rim pieces 30 (See FIG. 1) cannot be compressed or stretched once the lenses are placed in the groves. So The left bridge area hook member 38 (See FIG. 1) and the right bridge area hook member 42 (See FIG. 1) is detachably attached to the hook engaging portion 24 (See FIG. 1) at the nose bridge area 22 (See FIG. 1) of the top frame piece 12 and the pair of bottom rim pieces 30 (See FIG. 1) can now swing into place while securing the lenses. Once the pair of bottom rim pieces 30 (See FIG. 1) swing into the correct position, the pair of earpieces 26 can be inserted into the pair of joints located at the pair of corners 44 of the top frame piece 12 to lock all the pieces of the frame 10 together.

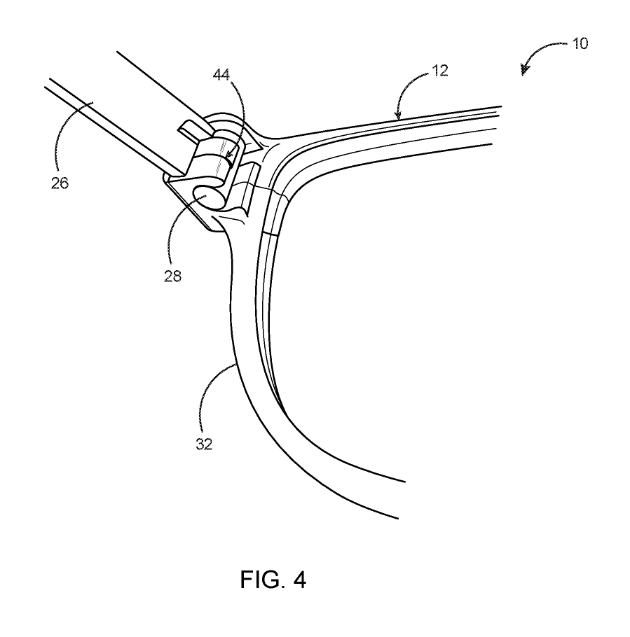

FIG. 4 shows perspective view of the interchangeable eyewear frame showing the pair of joints located at the pair of corners 44 of the top frame piece 12 holding the pair of earpieces 26, the top frame piece 12 and an outer edge of the pair of bottom rim pieces 30 (See FIG. 1) together according to the preferred embodiment of the present invention. The pair of earpieces 26 can be inserted into the eyewear frame 10 by sliding the earpiece appendage 28 into the left corner opening 18 (See FIG. 1) and the right corner opening 20 (See FIG. 1) located at the pair of joints at the pair of corners 44 of the top frame piece 12 after flattening the pair of earpieces 26. The pair of earpieces 26 can be flattened by gently pressing down and slide the earpiece appendage 28 into the left corner opening 18 (See FIG. 1) and the right corner opening 20 (See FIG. 1) located at the pair of joints at the pair of corners 44 of the top frame piece 12, once the earpiece appendage 28 aligns with the left corner and right corner openings 18 and 20 (See FIG. 1). The pair of earpieces 26 can be detached from the left corner opening 18 (See FIG. 1) and the right corner opening 20 (See FIG. 1) located at the pair of joints at the pair of corners 44 of the top frame piece 12 by pressing down and flattening the pair of earpieces 26. This will allow the earpiece appendage 28 to line up with the left corner opening 18 (See FIG. 1) and the right corner opening 20 (See FIG. 1) located at the pair of joints at the pair of corners 44 of the top frame piece 12 so the pair of earpieces 26 can then detached. If the pair of earpieces 26 is not flattened, the earpiece appendage 28 will not align with the left corner and right corner openings 18 and 20 (See FIG. 1) located at the pair of joints at the pair of corners 44 of the top frame piece 12 and then the pair of earpieces 26 cannot slide out. The top frame piece 12 and the pair of bottom rim pieces 30 (See FIG. 1) will no longer be locked together once the pair of earpieces 26 is detached. The pair of earpieces 26 is incorporated with a bend or an arch in order to allow the pair of earpieces 26 to comfortably wrap around the side of a user's head. The arch in the pair of earpieces 26 is also designed such that the earpiece appendage 28 will not be freely slide in or out left corner opening 18 (See FIG. 1) and the right corner opening 20 (See FIG. 1) at the pair of joints located at the pair of corners 44 of the top frame piece 12 unless the pair of earpieces 26 is pressed down to flatten.

FIGS. 5 & 6 illustrate front and side perspective view of the interchangeable eyewear frame 10 wherein the top frame piece 12, the pair of bottom rim pieces 30 and the pair of earpieces 26 are locked together according to the preferred embodiment of the present invention. The eyewear frame 10 allows the top frame piece 12, the pair of bottom rim pieces 30 and the pair of earpieces 26 to be connected together without the use of hardware such as screws or hinges. The eyewear frame 10 allows interchangeability of the top frame piece 12, the pair of bottom rim pieces 30 and the pair of earpieces 26 with different colored pieces to create numerous variations and styles. Even if the eyewear frame 10 focuses the attention on fashion market, the frame will certainly be capable of housing prescription lenses, if the user wishes to have them made for their own use, or if prescription lenses are offered with the product in future. Since the eyewear frame 10 is made from TR90, a very flexible memory plastic material that can be twisted or deformed and will still return to its original shape. This will prevent damages to the eyewear frame 10 when the user changes the frame pieces frequently and also allow for a more comfortable fit. The eyewear frame 10 allows the user to modify their frame and change the color or design rather than purchasing a completely new frame in a different color or design. Users have the option to purchase different colored pieces that they like and interchange them with other pieces. Buying separate pieces is far more affordable to users than purchasing complete new frames.

While a particular form of the invention has been illustrated and described, it will be apparent that various modifications can be made without departing from the spirit and scope of the invention. Accordingly, it is not intended that the invention be limited, except as by the appended claims.

What is claimed is:

1. An interchangeable eyewear frame comprising:
a top frame piece having a pair of corners and a nose bridge area, the pair of corners includes a left side corner and a right side corner each having a left corner opening and a right corner opening respectively, the nose bridge area includes a hook engaging portion;
a pair of earpieces, each of the pair of earpieces includes an earpiece appendage allowing the pair of earpieces to slide into the left corner opening and the right corner opening located at the pair of corners of the top frame piece;
a pair of bottom rim pieces having a left rim piece and a right rim piece, the left rim piece includes a first corner hook member and a left bridge area hook member and the right rim piece includes a second corner hook member and a right bridge area hook member, the left bridge area hook member and the right bridge area hook member being detachably attached to the hook engaging portion at the nose bridge area of the top frame piece, the first corner hook member and the second corner hook member being detachably engaged with the left corner opening and the right corner opening of the top frame piece respectively; and
a plurality of joints located at the pair of corners of the top frame piece to hold the pair of earpieces, the top frame piece and an outer edge of the pair of bottom rim pieces together, the plurality of joints includes a pair of inside joints on the nose bridge area of the top frame piece for connecting another end of the pair of bottom rim pieces to the top frame piece;
whereby the pair of earpieces attached from the inside of the frame is rotated to the normal wearing position thereby locking the pair of earpieces together with the bottom rim pieces and the top frame piece providing interchangeability to create numerous variations and styles to the eyewear frame.

2. The eyewear frame of claim 1 wherein the top frame piece and the pair of bottom rim pieces are locked together by means of the pair of earpieces and the pair of earpieces, the top frame piece, the pair of bottom rim pieces and the pair of lenses are interchangeable without use of any type of connecting means and hardware tools.

3. The eyewear frame of claim 1 wherein the pair of earpieces can be detached from the left corner opening and the right corner opening located at the pair of corners of the top frame piece by pressing down and flattening the pair of earpieces.

4. The eyewear frame of claim 1 wherein the pair of earpieces can be inserted into the eyewear frame by sliding the ear piece appendage into the left corner opening and the right corner opening located at the pair of corners of the top frame piece after flattening the pair of earpieces.

5. An interchangeable eyewear frame comprising:
a top frame piece having a pair of corners and a nose bridge area, the pair of corners includes a left side corner and a right side corner, each having a left corner opening and a right corner opening respectively;
a pair of earpieces, each of the pair of earpieces includes an earpiece appendage allowing the pair of earpieces to slide into the left corner opening and the right corner opening located at the pair of corners of the top frame piece;
a pair of bottom rim pieces having a left rim piece and a right rim piece, the left rim piece includes a first corner hook member and a left bridge area hook member and the right rim piece includes a second corner hook member and a right bridge area hook member, and
a plurality of joints located at a pair of corners of the top frame piece to hold the pair of earpieces, the top frame piece and an outer edge of the pair of bottom rim pieces together, the plurality of joints includes a pair of inside joints on the nose bridge area of the top frame piece for connecting another end of the pair of bottom rim pieces to the top frame piece;
whereby the pair of earpieces attached from the inside of the frame is rotated to the normal wearing position thereby locking the pair of earpieces together with the bottom rim pieces and the top frame piece providing interchangeability to create numerous variations and styles to the eyewear frame.

6. The eyewear frame of claim 5 wherein the nose bridge area of the top frame piece includes a hook engaging portion to which the left bridge area hook member and the right bridge area hook member are detachably attached.

7. The eyewear frame of claim 5 wherein the first corner hook member and the second corner hook member being detachably engaged with the left corner opening and the right corner opening of the top frame piece respectively.

8. The eyewear frame of claim 5 wherein the top frame piece and the pair of bottom rim pieces are locked together by means of the pair of earpieces and the pair of earpieces, the top frame piece, the pair of bottom rim pieces and the pair of lenses are interchangeable without use of any type of connecting means and hardware tools.

9. The eyewear frame of claim 5 wherein the pair of earpieces can be detached from the left corner opening and the right corner opening located at the pair of corners of the top frame piece by pressing down and flattening the pair of earpieces.

10. The eyewear frame of claim 5 wherein the pair of earpieces can be inserted into the eyewear frame by sliding the ear piece appendage into the left corner opening and the right corner opening located at the pair of corners of the top frame piece after flattening the pair of earpieces.

11. An interchangeable eyewear frame comprising:
a top frame piece, the top frame piece includes a pair of corners and a nose bridge area;
a pair of earpieces, each of the pair of earpieces includes an earpiece appendage;
a pair of bottom rim pieces, the pair of bottom rim pieces includes a left rim piece and a right rim piece; and
a plurality of joints located at a pair of corners of the top frame piece to hold the pair of earpieces, the top frame piece and an outer edge of the pair of bottom rim pieces together, the plurality of joints includes a pair of inside joints on the nose bridge area of the top frame piece for connecting another end of the pair of bottom rim pieces to the top frame piece;
whereby the pair of earpieces attached from the inside of the frame is rotated to the normal wearing position thereby locking the pair of earpieces together with the bottom rim pieces and the top frame piece providing interchangeability to create numerous variations and styles to the eyewear frame.

12. The eyewear frame of claim 11 wherein the pair of corners of the top frame piece includes a left side corner and a right side corner each having a left corner opening and a right corner opening respectively.

13. The eyewear frame of claim 11 wherein the earpiece appendage of the pair of earpieces allows the pair of earpieces to slide into the left corner opening and the right corner opening located at the pair of corners of the top frame piece.

14. The eyewear frame of claim 11 wherein the left rim piece of the pair of bottom rim pieces includes a first corner hook member and a left bridge area hook member.

15. The eyewear frame of claim 11 wherein the right rim piece of the pair of bottom rim pieces includes a second corner hook member and a right bridge area hook member.

16. The eyewear frame of claim 11 wherein the nose bridge area of the top frame piece includes a hook engaging portion to which the left bridge area hook member and the right bridge area hook member are detachably attached.

17. The eyewear frame of claim 11 wherein the first corner hook member and the second corner hook member being detachably engaged with the left corner opening and the right corner opening of the top frame piece respectively.

18. The eyewear frame of claim 11 wherein the top frame piece and the pair of bottom rim pieces are locked together by means of the pair of earpieces and the pair of earpieces, the top frame piece, the pair of bottom rim pieces and the pair of lenses are interchangeable without use of any type of connecting means and hardware tools.

19. The eyewear frame of claim 11 wherein the pair of earpieces can be detached from the left corner opening and the right corner opening located at the pair of corners of the top frame piece by pressing down and flattening the pair of earpieces.

20. The eyewear frame of claim 11 wherein the pair of earpieces can be inserted into the eyewear frame by sliding the earpiece appendage into the left corner opening and the right corner opening located at the pair of corners of the top frame piece after flattening the pair of earpieces.
